(19) United States
(12) Patent Application Publication
(10) Pub. No.: US 2002/0008517 A1
(43) Pub. Date: Jan. 24, 2002

(54) Octagon shaped flexible intermediate bulk container and method of manufacture

(76) Inventors: Norwin C. Derby, West Tawakoni, TX (US); Bobby Glenn Brown, Dennison, TX (US)

Correspondence Address: Michael A. O'Neil, Michael A. O'Neil, P.C., Suite 1030, 5949 Sherry Lane, Dallas, TX, 75225, US

(21) Appl. No.: 09/968,819

(22) Filed: Oct. 1, 2001

Related U.S. Application Data
(63) Continuation-in-part of application No. 09/771,270, filed on Jan. 26, 2001.
Application No. 09/771,270 is a continuation of application No. 09/515,631, filed on Feb. 29, 2000, now Pat. No. 6,244,443.
Application No. 09/515,631 is a continuation-in-part of application No. 09/458,362, filed on Dec. 9, 1999, now Pat. No. 6,220,755.
Application No. 09/458,362 is a continuation-in-part of application No. 09/390,403, filed on Sep. 3, 1999, now Pat. No. 6,203,198.

(51) Int. Cl. G01V 3/00; B65D 19/00; B65D 33/06

(52) U.S. Cl. 324/318; 206/600; 206/386; 383/119; 220/4.29; 383/16; 324/309; 324/322

(57) ABSTRACT

An octagon shaped flexible intermediate bulk container is formed from a unitary subassembly comprising alternating stiffening panel receiving pockets and high strength sections. The stiffening panel receiving pockets comprise spaced apart single layer woven panels, and the high strength sections comprise integral structures woven from the same fiber utilized in the fabrication of the single layer woven panels comprising the stiffening panel receiving pockets.

### CROSS REFERENCE TO RELATED APPLICATIONS

This is a continuation-in-part application under 37 C.F.R. §1.63 of application Ser. No. 09/771,270 filed Jan. 26, 2001, currently pending, which is a continuation application of Application Serial No. 09/515,631 filed Feb. 29, 2000, now U.S. Pat. No. 6,244,443, which is a continuation-in-part of application Ser. No. 09/458,362 filed Dec. 9, 1999, now U.S. Pat. No. 6,220,755, which is a continuation-in-part of application Ser. No. 09/390,403 filed Sep. 3, 1999, now U.S. Pat. No. 6,203,198.

### TECHNICAL FIELD

The present invention relates generally to flexible intermediate bulk containers, and more particularly to an octagon shaped flexible intermediate bulk container formed from a unitary length of woven fabric comprising alternating stiffening panel receiving pockets and high strength sections.

### BACKGROUND AND SUMMARY OF THE INVENTION

U.S. Pat. No. 6,244,443 granted Jun. 12, 2001 to Nickell, et al. and assigned to the assignee hereof discloses and claims an octagon shaped stackable flexible intermediate bulk container a.k.a. bulk bag, and a method of manufacturing the octagon shaped bulk bag. In accordance with the method of the '443 patent, two substantially identical sheets of woven polypropylene fabric are positioned one on top of the other with the sides and ends of the sheets in alignment. The sheets are joined by seven transversely extending sew lines and the opposite ends of the sheets are sewn together to define eight stiffening panel receiving pockets. A bottom wall is attached to one end of the resulting construction by sewing, a stiffening panel is inserted into each of the stiffening panel receiving pockets, and the tops of the stiffening panel receiving pockets are thereafter closed by sewing.

The present invention comprises an octagon shaped flexible intermediate bulk container a.k.a. bulk bag and a method for manufacturing the octagon shaped bulk bag which incorporates a substantial improvement over the octagon shaped bulk bag and the manufacturing method of the '443 patent. In accordance with the present invention an octagon shaped bulk bag is fabricated from a unitary length of woven fabric comprising alternating stiffening panel receiving pockets and high strength sections. More particularly, the stiffening panel receiving pockets comprise spaced apart woven polypropylene fabric sections each comprising perpendicularly extending warp and woof polypropylene tapes or filaments. The alternating high strength sections comprise the same polypropylene tapes or filaments which are utilized in the fabrication of the woven polypropylene fabric sections comprising the stiffening panel receiving pockets, but which are woven together to define integral high strength sections having approximately twice the density and substantially greater strength as compared with the woven polypropylene fabric panels of the stiffening panel receiving pocket.

The use of the high strength sections in the fabrication of the octagon shaped bulk bag of the present invention comprises at least two distinct advantages over the prior art as represented by the octagon shaped bulk bag and method of manufacture of the '443 patent. First, the use of the high strength sections of the present invention eliminates the necessity of forming transversely extending sew lines to define the stiffening panel receiving pockets of an octagon shaped bulk bag. Second, the use of the high strength sections of the present invention provides a convenient location for the attachment of lift loops which are commonly employed in bulk bag manufacture. Other advantages deriving from the use of the method of the present invention will readily suggest themselves to those skilled in the art.

### BRIEF DESCRIPTION OF THE DRAWINGS

A more complete understanding of the present invention may be had by reference to the following Detailed Description, when taken in conjunction with the accompanying Drawings, wherein:

FIG. 1 is a perspective view illustrating an octagon shaped flexible intermediate bulk container constructed in accordance with the invention in which certain parts have been broken away more clearly to illustrate certain features of the invention;

FIG. 2 is an illustration of the major component part of the octagon shaped flexible intermediate bulk container of FIG. 1 in which certain parts have been broken away more clearly to illustrate certain features of the invention;

FIG. 3 is an enlargement of a portion of FIG. 2 in which certain parts have been broken away more clearly to illustrate certain features of the invention; and

FIG. 4 is a top view of the octagon shaped flexible intermediate container of FIG. 1 in which certain component parts have been broken away more clearly to illustrate features of the invention.

### DETAILED DESCRIPTION

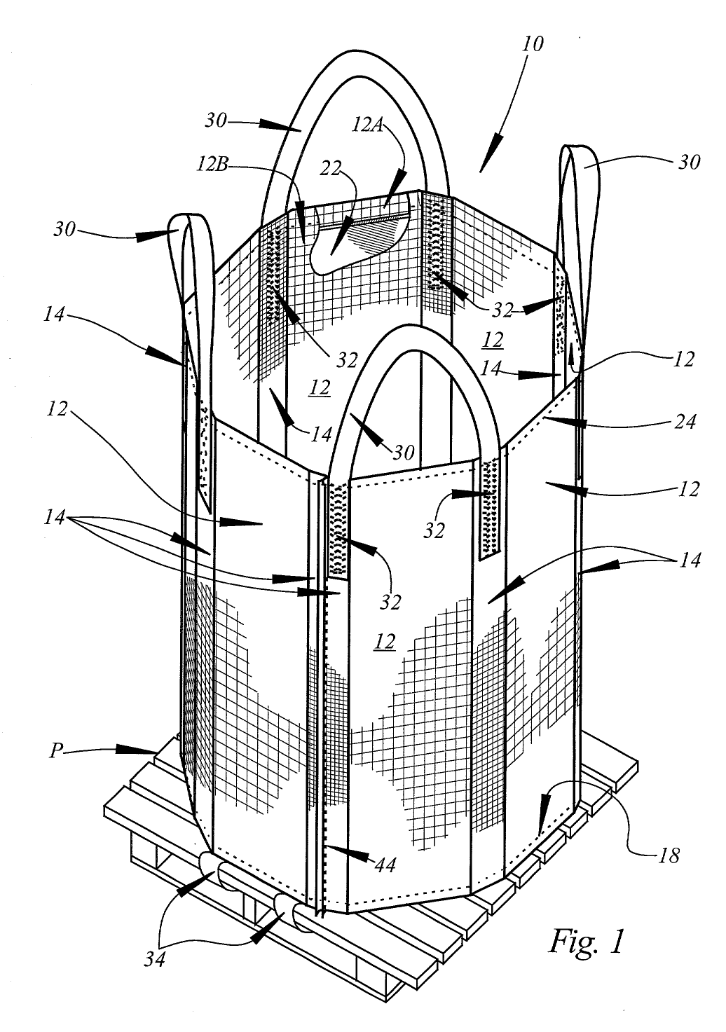

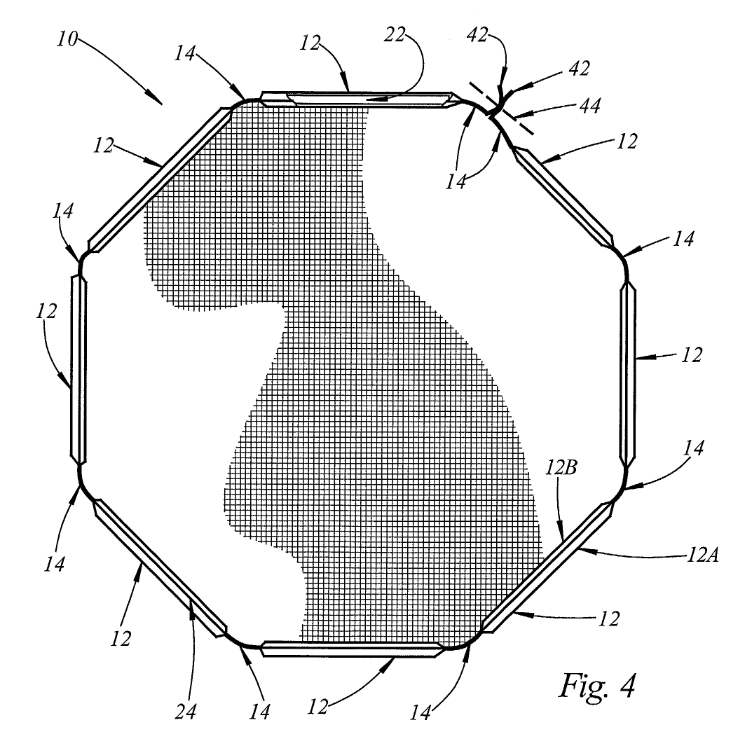

Referring now to the Drawings, and particularly to FIGS. 1 and 4, there is shown an octagon shaped flexible intermediate bulk container 10 incorporating in the present invention. As is well known by those skilled in the art, flexible intermediate bulk containers are commonly known as bulk bags. The bulk bag 10 comprises eight substantially identical stiffening panel receiving pockets 12. The pockets 12 are separated by substantially identical high strength sections 14. The bulk bag 10 further includes a bottom wall 16 which is secured to the stiffening panel receiving pockets 12 and the high strength sections 14 by sewing as indicated by the sew line 18.

Each of the stiffening panel receiving 12 receives a stiffening panel 22. The stiffening panels 22 of the present invention may be manufactured from plastic panels of the type sold by Coroplast of Dallas, Tex., under the trademark COREX(TM). Other types of plastic panels may also be used, depending upon the requirements of particular applications of the invention. The stiffening panels 22 may also be formed from various types of paperboard; fiberboard, including medium density fiberboard (MDF); cardboard; plywood; and other materials depending upon the ability of stiffening panels formed from such materials to resist bending. After the stiffening panels 22 are positioned in the pockets 12, each of the pockets 12 may be closed at its upper end by sewing, as indicated by the sew line 24. Alternatively, the stiffening panels 22 may be removably retained in the pockets 12 by snaps, hook-and-loop fasteners, etc., thereby facilitating folding of the bulk bag 10 for the storage or shipment.

Referring particularly to FIG. 1, the bulk bag 10 may be provided with a plurality of lift loops 30 depending upon the requirements of particular applications of the invention. If used, the lift loops 30 are preferably secured to the high strength sections 14 by sewing as indicated at 32. The bulk bag 10 may also be provided with tabs 34 which are fastened to the bottom wall 16 by sewing and which are utilized to secure the bulk bag 10 to a pallet P. The tabs 34 may be used in addition to or in lieu of the lift loops 30 depending upon the requirements of particular applications of the invention. Those skilled in the art will appreciate the fact that the bulk bag may be provided with other types and kinds of lifting and/or securing apparatus, if desired.

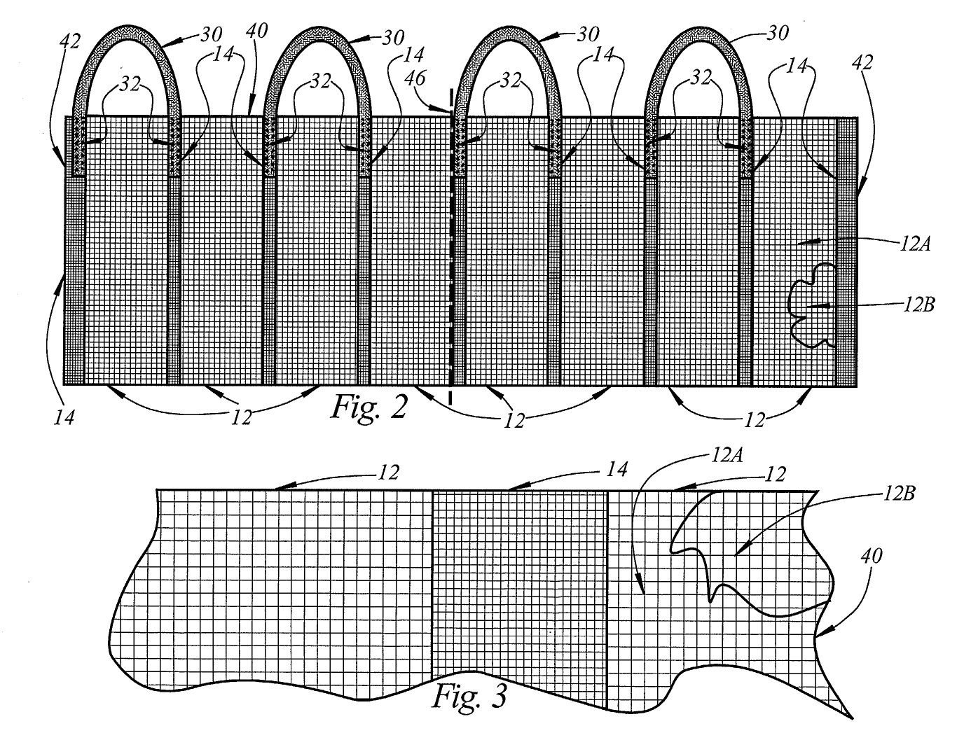

The method of the present invention is illustrated in FIGS. 2 and 3. The stiffening panel receiving pockets 12 and the high strength sections 14 comprise unitary subassembly 40. The stiffening panel receiving pockets 12 of the subassembly 40 each comprise spaced apart single layer panels 12A and 12B. The single layer panels 12A and 12B comprising the stiffening panel receiving pockets 12 comprise warp and woof fibers which may comprise either tapes or filaments formed from polypropylene, polyethylene or other plastic materials depending upon the requirements of particular applications of the invention. The warp and woof fibers are woven in the conventional manner to form spaced apart single layer panels 12A and 12B comprising each stiffening panel receiving pocket 12.

The high strength sections 14 of the subassembly 40 are fabricated utilizing the same warp and woof fibers that are utilized in the fabrication of the single layer panels comprising the stiffening panel receiving pockets 12. However, within the high strength sections 14 the warp and woof fibers utilized in the fabrication of the spaced apart panels comprising the stiffening panel receiving pockets 12 are woven into an integrated structure having substantially twice the density and considerably more strength as compared with one of the single layer panels comprising the stiffening panel receiving pockets 12.

The subassembly 40 includes high strength end sections 42 which are formed identically to the high strength sections 14. The end sections 42 are joined together by sewing as indicated by the sew line 44 (FIGS. 1 and 4). If used, the lift loops 30 are preferably secured to the high strength sections 14 prior to the joinder of the end sections 42. As will be appreciated by those skilled in the art, the increased density and strength of the high strength sections 14 provides a superb attachment point for the lift loops 30.

The increased density and strength of the high strength sections 14 of the subassembly 40 as compared with that of the single layer panels comprising the stiffening panel receiving pockets 12 is diagrammatically illustrated in FIG. 3 wherein the lift loops 30 are omitted for clarity. As is indicated above, and as will be appreciated by those skilled in the art, the same warp and woof fibers which are utilized in the construction of the single layer panels comprising the stiffening panel receiving pockets 12 are utilized in the construction of the high strength sections 14. Therefore, in actual practice, there is not a clear line of demarkation between the single layer panels comprising the pockets 12 and the integral construction of the high strength sections 14.

Additional embodiments of the invention are diagrammatically illustrated in FIG. 2. In the embodiment of the invention hereinabove, the subassembly 40 comprises eight stiffening panel receiving pockets 12 having reference to the dashed line 46, a second embodiment of the invention comprises two subassemblies 40 each comprising four stiffening panel receiving pockets 12. In accordance with a third embodiment of the invention, four subassemblies 40 are provided each comprising two stiffening panel receiving pockets 12. As will be appreciated by those skilled in the art, an end section 42 is provided at each end of each subassembly 40 regardless of how many subassemblies 40 are utilized in the construction of a bulk bag.

It will therefore be understood that the present invention comprises an improvement over the octagon shaped bulk bag and the method of manufacturing octagon shaped bulk bags disclosed and claimed in U.S. Pat. No. 6,244,443. In particular, the method of the present invention eliminates the sewing step which is necessary to separate the stiffening panel receiving pockets of the bulk bag of the '443 patent. In lieu thereof, the method of the present invention provides high strength sections interposed between the stiffening panel receiving pockets which provides superior strength and afford a convenient location for the attachment of the lift loops.

Although preferred embodiments of the invention have been illustrated in the accompanying drawings and described in the foregoing Detailed Description, it will be understood that the invention is not limited to the embodiments disclosed, but is capable of numerous rearrangements, modifications, and substitutions of parts and elements without departing from the spirit of the invention.

What is claimed is:

1. A flexible intermediate bulk container comprising:
a unitary subassembly having top and bottom edges and opposed ends and comprising alternating stiffening panel receiving pockets and high strength sections;
the opposed ends of the unitary subassembly being joined together to form the unitary subassembly into an enclosure;
a bottom wall secured to the bottom edge of the unitary subassembly;
a plurality of stiffening panels each received in one of the stiffening panel pockets of the unitary subassembly; and
means located at the top edge of the unitary subassembly for retaining the stiffening panels in the stiffening panel receiving pockets.

2. The flexible intermediate bulk container according to claim 1 wherein the stiffening panel receiving pockets of the unitary subassembly comprise spaced apart single layer woven fabric panels and wherein the high strength sections comprise integral structures woven from the same fibers comprising the single layer woven fabric panels of the stiffening panel receiving pockets.

3. The flexible intermediate bulk container according to claim 1 wherein the opposed ends of the unitary subassembly are joined together by sewing.

4. The flexible intermediate bulk container according to claim 1 wherein the bottom wall is secured to the bottom edge of the unitary subassembly by sewing.

5. The flexible intermediate bulk container according to claim 1 wherein the stiffening panels are formed from corrugated plastic sheeting.

6. The flexible intermediate bulk container according to claim 1 wherein the stiffening panels are formed from fiberboard.

7. The flexible intermediate bulk container according to claim 1 wherein the stiffening panels are formed from plywood.

8. The flexible intermediate bulk container according to claim 1 wherein the stiffening panels are retained in the stiffening panel receiving pockets by sewing.

9. The flexible intermediate bulk container according to claim 1 wherein the stiffening panels are releaseably retained in the stiffening panel receiving pockets.

10. The flexible intermediate bulk container according to claim 1 wherein the opposed ends of the unitary subassembly are joined together by sewing, wherein the bottom wall is secured to the bottom edge of the unitary subassembly by sewing, and wherein the stiffening panels are retained in the stiffening panel receiving pocket by sewing.

11. An octagon shaped flexible intermediate bulk container comprising:
a unitary subassembly having top and bottom edges and opposed ends and comprising eight stiffening panel receiving pockets and seven high strength sections located between adjacent stiffening panel receiving pockets and high strength end sections located at the ends of the subassembly;
the high strength end sections of the unitary subassembly being joined together to form the unitary subassembly into an enclosure;
a bottom wall secured to the bottom edge of the unitary subassembly;
eight stiffening panels each received in one of the eight stiffening panel receiving pockets of the unitary subassembly; and
means located at the top edge of the unitary subassembly for retaining the stiffening panels in the stiffening panel receiving pockets.

12. The flexible intermediate bulk container according to claim 11 wherein the stiffening panel receiving pockets of the unitary subassembly comprise spaced apart single layer woven fabric panels and wherein the high strength sections comprise integral structures woven from the same fibers comprising the stiffening panel receiving pockets.

13. The flexible intermediate bulk container according to claim 11 wherein the high strength end sections of the unitary subassembly are joined together by sewing.

14. The flexible intermediate bulk container according to claim 11 wherein the bottom wall is secured to the bottom edge of the unitary subassembly by sewing.

15. The flexible intermediate bulk container according to claim 11 wherein the stiffening panels are formed from corrugated plastic sheeting.

16. The flexible intermediate bulk container according to claim 11 wherein the stiffening panels are formed from fiberboard.

17. The flexible intermediate bulk container according to claim 11 wherein the stiffening panels are formed from plywood.

18. The flexible intermediate bulk container according to claim 11 wherein the stiffening panels are retained in the stiffening panel receiving pockets by sewing.

19. The flexible intermediate bulk container according to claim 11 wherein the stiffening panels are releaseably retained in the stiffening panel receiving pockets.

20. The flexible intermediate bulk container according to claim 11 wherein the opposed ends of the unitary subassembly are joined together by sewing, wherein the bottom wall is secured to the bottom edge of the unitary subassembly by sewing, and wherein the stiffening panels are retained in the stiffening panel receiving pocket by sewing.

21. For use in manufacturing a flexible intermediate bulk container, a unitary subassembly comprising alternating stiffening panel receiving pockets and high strength sections.

22. The unitary subassembly of claim 21 which comprises a woven fabric construction.

23. The unitary subassembly of claim 21 wherein the stiffening panel receiving pockets comprise spaced apart single layer woven panels formed from predetermined fibers and wherein the high strength sections comprise the same fibers utilized in the construction of the spaced apart panels of the stiffening panel receiving pockets which are woven into a high strength construction.

24. The unitary subassembly of claim 23 wherein the entire unitary subassembly is formed from polyethylene.
